(19) United States
(12) Patent Application Publication
(10) Pub. No.: US 2019/0288570 A1
(43) Pub. Date: Sep. 19, 2019

(54) AN ELECTROMAGNET COMPONENT COMPRISING MAGNETITE FOR USE IN A GENERATOR

(71) Applicant: THE TRUSTEES FOR THE TIME BEING OF THE KMN FULFILMENT TRUST, Benoni (ZA)

(72) Inventors: Kabu Walter Makgeru, Benoni (ZA); Anthony Bass, Bedfordview (ZA)

(21) Appl. No.: 16/318,664

(22) PCT Filed: Oct. 23, 2017
(86) PCT No.: PCT/IB2017/056569

§ 371 Date: Jan. 17, 2019

(30) Foreign Application Priority Data
Oct. 24, 2016 (ZA) 2016/07301

(51) Int. Cl. H02K 1/02; H02K 1/26; H02K 17/42

(52) U.S. Cl. CPC H02K 1/02; H02K 17/42; H02K 1/26

(57) ABSTRACT

An electromagnet component (100) for use in a generator comprises at least one magnetic shoe (102) comprising magnetite and a binder, the shoe (102) being at least partially arcuate in cross-section. A metallic core (110) is provided adjacent the magnetic shoe (102) and operatively radially spaced therefrom. A generator comprises one or more of the electromagnet components (100).

### FIELD OF INVENTION

This invention relates to rotary machines and generators in particular, and it relates specifically to an electromagnet component comprising magnetite for use in a generator.

### BACKGROUND OF INVENTION

An electric generator usually has an electromagnet as an essential part. Most electromagnets have a core made of steel (e.g., high nickel steel) as the material to generate the magnetic properties of the electromagnets. Windings, e.g. copper coils, are provided around the steel core and a current is passed through the windings to induce a magnetic field in and around the steel core. In order for the induced magnetic field to be useful, the electromagnet must have certain properties. For example, it needs to be able to produce magnetic flux of a sufficiently high density, dispersed in the right directions, and (depending on the construction of the generator) the core needs enough strength to be able to carry a centrifugal load necessitated by the operation of the generator.

Although steel has some favourable characteristics (that is, it is strong and produces useful magnetic flux), it also has unfavourable characteristics: it is heavy, it is difficult to machine, and it is relatively expensive. The Inventor aims to provide an electromagnet or a component for an electromagnet which overcomes or ameliorates at least one, and ideally more, of these drawbacks. It is an object of the invention to provide an electromagnet or an electromagnet component for a generator which is made from a combination of materials including magnetite, one material compensating for a weakness of another material.

The closest prior art of which the Inventor is aware is as follows:
GB 463783 discloses a rotor which is intended for co-operation with a stator of a self-starting synchronous motor. The rotor is made up of ferric oxide, Cobalt oxide, and magnetite in specific amounts.
CN 1691467 discloses a motor with a rotor and stator. The stator includes magnetite and it is radially magnetically charged.

It is pointed out that both of these patent documents relate to motors and their teachings are thus a degree removed from generators.

### SUMMARY OF INVENTION

Accordingly, the present invention provides an electromagnet component for use in a generator, the electromagnet component comprising:
at least one magnetic shoe comprising magnetite and a binder, the shoe being at least partially arcuate in cross-section; and
a metallic core provided adjacent the magnetic shoe and operatively radially spaced therefrom.

The electromagnet component may comprise two magnetic shoes, namely an inner shoe and an outer shoe, each of the shoes comprising magnetite and a binder. Each of the shoes may have an arcuate cross section. The shoes may be operatively radially spaced relative to each other. The metallic core may be provided between the shoes.

The core may serve as a spacer to support the two shoes apart, e.g., a short distance apart. In one embodiment, the core may be elongate and cylindrical, e.g., having a round or rectangular cross-sectional profile. In another embodiment, the core may have a T-shaped cross-sectional profile or an I- or H-shaped cross-sectional profile.

The core may be of steel. The core may be smaller than that of a comparable prior art generator (i.e., a generator not having at least one magnetic shoe comprising magnetite and a binder).

The (or each) shoe may include a reinforcing component embedded therein. The reinforcing component may increase a structural strength or rigidity of the shoe. The reinforcing component may be a mesh. The reinforcing component may be fibres. The reinforcing component may be steel wire.

The binder may comprise resin. The resin may be high-strength resin.

The magnetite may be high-quality magnetite with >90% magnetics for improved magnetic dispersion properties. Magnetic particles in the magnetite may be aligned for improved magnetic properties.

The (or each) shoe may have, or may be, a sacrificial layer. The sacrificial layer may take the place of an air gap in a prior art generator. The shoe may have two layers: a basal, non-sacrificial layer and the sacrificial layer which may be a surface layer.

The electromagnet component may include a dispersion layer. The dispersion layer may be a metallic layer. The dispersion layer may be a thin metallic layer or plate, e.g., high nickel steel or electric steel. The shape of the dispersion layer may match the shape of the shoe, with the dispersion layer and the shoe being in contact with each other.

The electromagnet component may include windings. The windings may be coiled around the core. The windings may be embedded in the shoe.

The invention extends to an electromagnet assembly comprising plural electromagnet components, which may be arranged side by side in a circle around an axis of rotation of a generator.

The invention extends to a generator including the electromagnet component as defined above. The generator may include plural electromagnet components. The generator may include one electromagnet component for each pole of the generator, e.g., a four pole generator may include four electromagnet components. The plural electromagnet components may be arranged side by side in a circle around an axis of rotation of the generator.

### BRIEF DESCRIPTION OF DRAWINGS

The invention will now be further described, by way of example, with reference to the accompanying diagrammatic drawings.

In the drawings:

FIG. 1 shows a three-dimensional view of a first embodiment of an electromagnet component in accordance with the invention;

FIG. 2 shows a three-dimensional view of a second embodiment of an electromagnet component in accordance with the invention;

FIG. 3 shows a three-dimensional view of a third embodiment of an electromagnet component in accordance with the invention;

FIG. 4 shows an end view of the electromagnet component of FIG. 3;

FIG. 5 shows a three-dimensional view of a fourth embodiment of an electromagnet component in accordance with the invention; and

FIG. 6 shows an end view of the electromagnet component of FIG. 5.

### DETAILED DESCRIPTION OF EXAMPLE EMBODIMENT

The following description of the invention is provided as an enabling teaching of the invention. Those skilled in the relevant art will recognise that many changes can be made to the embodiment described, while still attaining the beneficial results of the present invention. It will also be apparent that some of the desired benefits of the present invention can be attained by selecting some of the features of the present invention without utilising other features. Accordingly, those skilled in the art will recognise that modifications and adaptations to the present invention are possible and can even be desirable in certain circumstances, and are a part of the present invention. Thus, the following description is provided as illustrative of the principles of the present invention and not a limitation thereof.

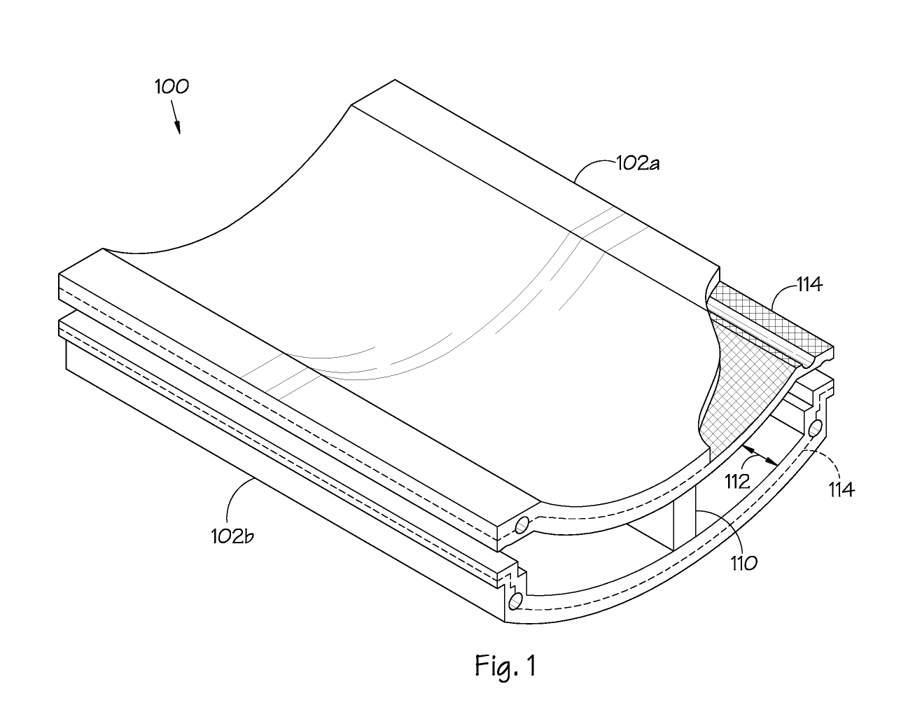

FIG. 1 illustrates a first embodiment of an electromagnet component 100 in accordance with the invention. The electromagnet component 100 comprises two magnetic shoes 102a, 102b (collectively referred to by numeral 102), namely an inner shoe 102a and an outer shoe 102b. Each shoe 102 comprises magnetite and a binder in the form of high-strength resin. (If only one of the shoes 102 was present, the electromagnet component 100 would still function, to some degree.)

The Inventor notes that magnetite (in its natural state) can be granular and soft. Even when compacted into a solid mass (without a binder) it is relatively soft and therefore easy to work and machine into different shapes. In this example, the shoes 102 are generally arcuate cross-sectional profile, each having an accurate main portion. The inner shoe 102a has straight side edges either side of the main portion, while the outer shoe 102b has inwardly stepped edges.

In this example, the shoes 102 have no external support structure. Accordingly, a reinforcing mesh 114 is provided inside (and co-planar with) each shoe 102. The reinforcing mesh 114 is of stainless steel and provides the shoe 102 with structural rigidity and strength (in similar fashion to rebar embedded in concrete). The mesh 114 does not add significantly to the weight of the shoe 102 (which, relative to stainless steel, is light).

A steel core 110 is provided between the shoes 102. In this example, the steel core has a rectangular cross-sectional profile but other profiles may be practicable. The steel core 110 provides a dual purpose in this example: it spaces the shoes 102 apart and it provides a core for the electromagnet component. The shoes 102 and core 110 are radially aligned relative to an axis of rotation of a generator (not illustrated) in the following order, moving outward from the axis: inner shoe 102a, core 110, and outer shoe 102b. A clearance gap 112 is provided between the shoes 102.

Windings (not illustrated) will be wound around the core 110 within the clearance gap 112.

Four similar or identical electromagnet components 100 are mounted side-by-side in a circular or annular series to provide a four-pole electromagnet arrangement for the generator.

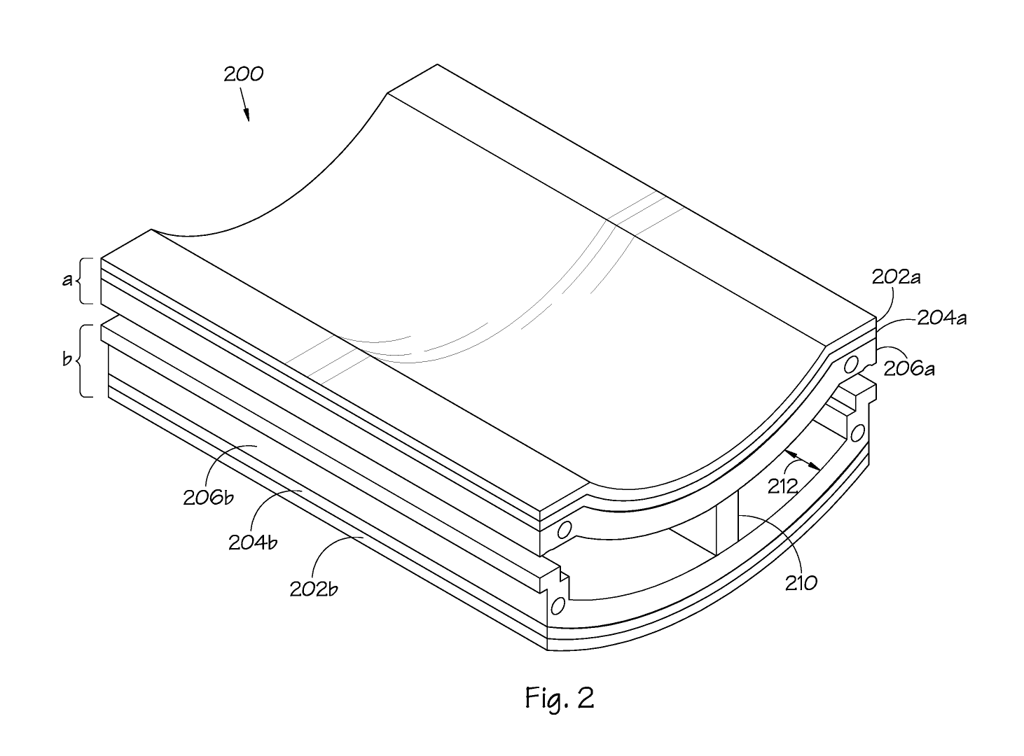

FIG. 2 illustrates a second embodiment of an electromagnet component 200 in accordance with the invention. The electromagnet component 200 comprises two magnetic shoes 202a, 204a, 206a; 202b, 204b, 206b, namely an inner shoe 202a, 204a, 206a (referred to a shoe (a)) and an outer shoe 202b, 204b, 206b (referred to as shoe (b)). An important difference of the electromagnet component 200 compared to electromagnet component of 100 FIG. 1 is that each shoe (a, b) of the electromagnet component 200 has plural layers 202, 204, 206.

Two of the layers 202, 204 comprise the magnetite and binder, while a third layer 206 is a metallic dispersion layer. Each shoe (a, b) has two magnetite layers 202, 204 because one layer 202, a surface layer 202a, 202b (collectively referred to with numeral 202) is sacrificial while the other magnetite layer 204, a mid or basal layer 204a, 204b (collectively referred to by numeral 204) of magnetite which is a permanent layer attached to the dispersion layer 206. The dispersion layer 206 is a relatively thin layer or plate of high nickel steel. The dispersion layer 206 assists in creating a desired magnetic flux density and layout.

The two shoes (a, b), and specifically the dispersion layers 206 of each shoe (a, b), are arranged either side of a steel core 210 which serves to space the shoes (a, b) a short distance 212 apart.

The width of the sacrificial layer 202 is matched to the width of an air gap in a conventional generator. Accordingly, the air gap in the present generator (which uses the electromagnet components 200) is replaced with the sacrificial layer and is therefore non-existent or much smaller. As a rotor (which will typically carry the electromagnet component 200) and stator of the generator rotate relative to each other, an exposed face of the sacrificial layer 202 will typically make contact with a relatively moving part (e.g., on the stator) and be worn away. As magnetite is relatively soft, this should cause no or negligible damage to the moving part and cause the sacrificial layer 202 to be worked for a perfect fit.

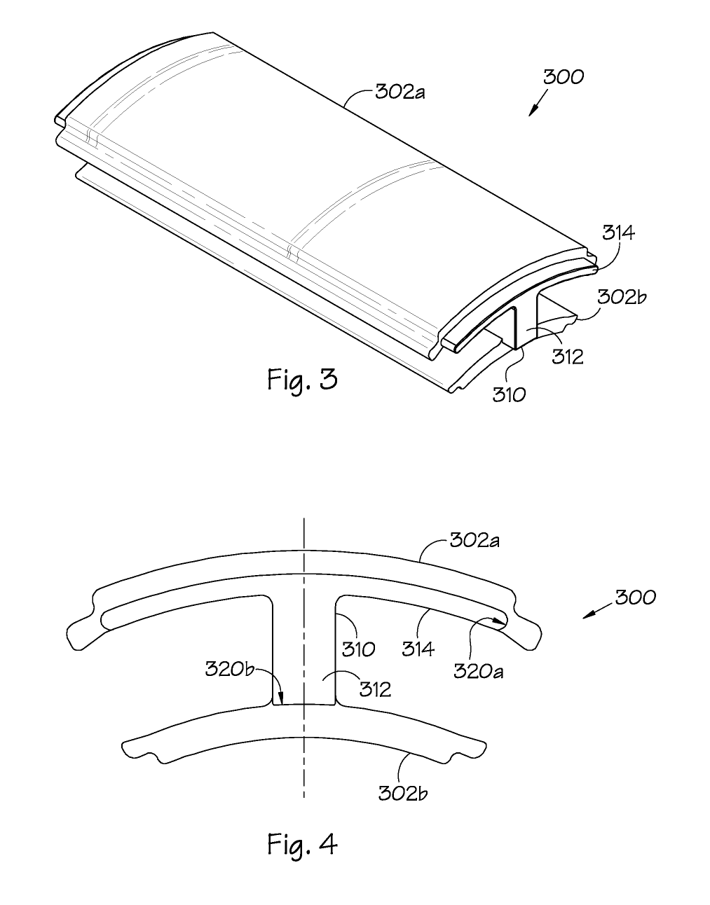

FIGS. 3 and 4 illustrate a third embodiment of an electromagnet component 300. In this example, the electromagnet component 300 has a core 310 which has a T-shaped cross-sectional profile, wherein a top piece 314 of the core 310 serves to support and strengthen an outer shoe 302a made of magnetite and a binder. An upright portion 312 of the core serves to space the outer shoe 302a and an inner shoe 302b (also of magnetite and a binder) a fixed radial distance apart from each other. The outer shoe 302a has lateral locating formations 320a to engage with the top piece 314 of the core, while the inner shoe 302b has a central locating formation 320b to engage with the upright portion 312.

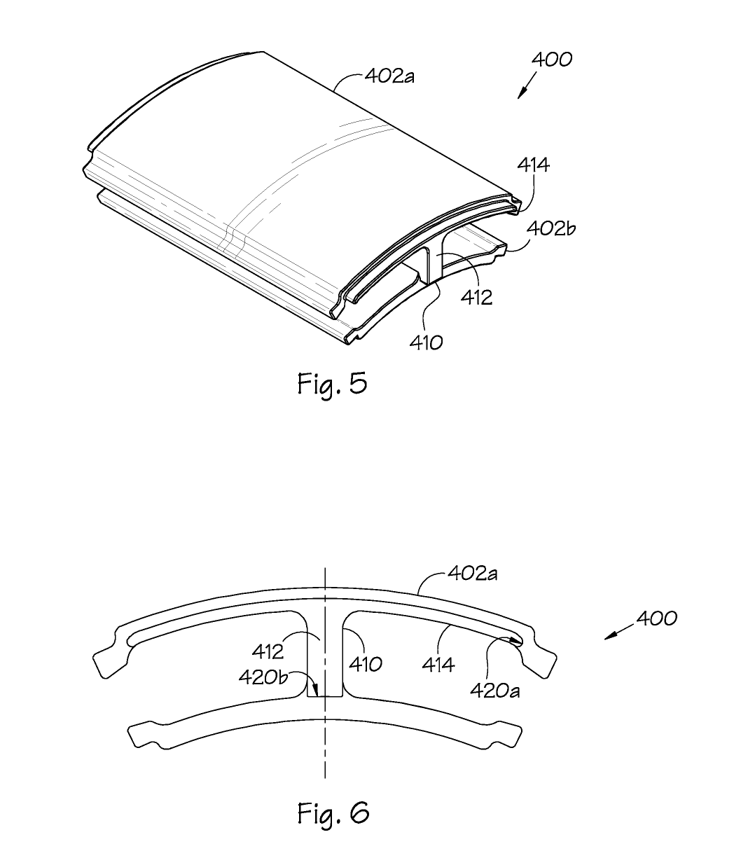

FIGS. 5 and 6 illustrate a fourth embodiment of an electromagnet component 400 in accordance with the invention, being very similar to the electromagnet component 300 of FIGS. 3 and 4. The electromagnet component 400 is slightly thinner and wider, with corresponding numerals (e.g., 302 and 402) representing corresponding parts. FIGS. 5 and 6 merely serve to illustrate that the electromagnet component 400 may take various forms while adhering to the inventive magnetite and binder with metallic core principle.

In a conventional (prior art) electromagnet design for generators, the steel core performs the dual function of generating magnetic flux and of dispersing the magnetic field. In the present invention, the magnetic flux generation and magnetic flux dispersion may be performed by one or two different materials: the magnetite shoe and/or the steel core.

The Inventor believes that the invention, as exemplified, has a number of advantages. Importantly, magnetite is much easier than steel to work, machine, form, and shape as desired. Accordingly, specific shapes and profiles of the magnetite shoes can easily be formed.

In an embodiment with a sacrificial magnetite layer (as in FIG. 2), the sacrificial magnetite layer can be worked and shaped, e.g., slef-machined, by the other relatively moving part of the generator, thereby to create the optimal (e.g., smallest) workable air gap, or even no airgap. This optimal working air gap is important because it reduces the distance between the rotor (which may generate the magnetic field) and the stator (which may carry the conductor) and therefore increases the EMF generated by virtue of the fact that EMF generated is inversely proportional to the distance between the rotor and stator. This will proportionally improve the efficiency of the generator. By way of practicality, the sacrificial layer may be worked before final assembly of the generator is done so that the dust generated can be removed without causing any damage.

Another potential advantage of magnetite is that copper wire forming the windings can be embedded into the magnetite layer and then the copper wire can perform the dual function of providing the current for magnetic field and providing strength for the rotor.

Because the magnetite is so easy to machine, the electromagnet surface provided by the shoe can be shaped in such a way that the magnetic field flux increases progressively to the centre from both sides by the effect of the decreasing air gap.

In another embodiment, the combination of the increasing copper windings within the magnetite shoe and the decreased air gap in the centre increases the rate of change which is directly proportional EMF generated. According to the Maxwell equation, the higher the rate of change of magnetic flux, the higher the EMF generated; that is to say that EMF is a derivative of the Magnetic Flux. This rate of change in other embodiments can be achieved by changing the surface area of the electromagnet, by making the surface area uniformly smaller towards the ends on both sides. By doing this, the centre becomes a stronger magnetic field and the strength progressively decreases towards the end and this increase the rate of change. In other embodiments, the combination of the decreasing air gap towards the centre, the increasing copper windings towards the centre and the increasing surface area of the electromagnet towards the centre will increase the rate of change and therefore the EMF generated.

Importantly, magnetite is relatively cheap, and in some industries is even considered a wasteful by-product. Thus, use of magnetite can vastly reduce overall cost of materials for manufacturing a generator.

Magnetite is also lighter than steel, which can reduce the weight of the generator, reduce momentum in use, increase life of bearings and axles, etc.

1. An electromagnet component for use in a generator, the electromagnet component comprising:
at least one magnetic shoe comprising magnetite and a binder, the shoe being at least partially arcuate in cross-section; and
a metallic core provided adjacent the magnetic shoe and operatively radially spaced from the magnetic shoe,
wherein the at least one shoe has, or is, a sacrificial layer.

2. The electromagnet component of claim 1, comprising two magnetic shoes, namely an inner shoe and an outer shoe, each of the shoes comprising magnetite and a binder.

3. The electromagnet component of claim 2, wherein each of the shoes has an arcuate cross section.

4. The electromagnet component of claim 2, wherein the shoes are operatively radially spaced relative to each other.

5. The electromagnet component of claim 2, wherein the metallic core is provided between the shoes.

6. The electromagnet component of claim 5, wherein the core serves as a spacer to support the two shoes apart.

7. The electromagnet component of claim 1, wherein the core is elongate and cylindrical.

8. The electromagnet component of claim 7, wherein the core has one of:
a round or rectangular cross-sectional profile;
a T-shaped cross-sectional profile; or
an I- or H-shaped cross-sectional profile.

9. The electromagnet component of claim 1, wherein the core is of steel.

10. The electromagnet component of claim 1, wherein at least one shoe includes a reinforcing component embedded therein.

11. The electromagnet component of claim 10, wherein the reinforcing component is one or more of:
a mesh;
fibres; and/or
steel wire.

12. The electromagnet component of claim 1, wherein the binder comprises resin.

13. The electromagnet component of claim 1, wherein magnetic particles in the magnetite are aligned.

14. (canceled)

15. The electromagnet component of claim 1, wherein the sacrificial layer takes the place of an air gap in a prior art generator.

16. The electromagnet component of claim 15, wherein the at least one shoe has two layers: a basal, non-sacrificial layer and the sacrificial layer which is a surface layer.

17. The electromagnet component of claim 1, comprising a dispersion layer which is metallic, the dispersion layer dispersing a magnetic flux or field which assists in creating a desired magnetic flux density and layout.

18. The electromagnet component of claim 17, wherein a shape of the dispersion layer matches the shape of the at least one shoe, with the dispersion layer and the at least one shoe being in contact with each other.

19. The electromagnet component of claim 1, comprising windings coiled around the core.

20. The electromagnet component of claim 19, wherein the windings are embedded in the at least one shoe.

21. The electromagnet component of claim 1, wherein the magnetite comprises at least 90% magnetic particles.

22. An electromagnet component of claim 1, comprising a +50% higher rate of magnetic flux change on its surface compared to prior art electromagnet components, the higher rate of change enabled by a combination of three parameters: (1) progressively decreasing an air-gap by a rate of 50% every quarter from a prior art airgap of 100 mm (^{˜}4 in.) to operating airgap of down to 1 mm (^{˜}0.04 in.); (2) changing at constant rate a surface area for the dispersion of magnetic flux so that the dispersion surface area becomes progressively bigger at the centre and smaller at the ends but not sharper; and (3) windings are more at the bigger surface area and less at smaller surface area, the rate of change of windings being the same as that of the surface area.

23. An electromagnet assembly comprising plural electromagnet components of claim 1, wherein the plural electromagnet components are arranged side by side in a circle around an axis of rotation of a generator.

24. A generator comprising at least one electromagnet component of claim 1.

25. The generator of claim 24, comprising plural electromagnet components, one electromagnet component for each pole of the generator.

26. The generator of claim 25, wherein the plural electromagnet components are arranged side by side in a circle around an axis of rotation of the generator.

27. A method of operating a generator comprising the electromagnet component of claim 1, wherein the electromagnet component bears against a relatively rotating component, the relatively rotating component accordingly bearing against and thereby machining the electromagnet component to create a complemental fit with a minimal or no airgap.
